(19) United States
(12) Patent Application Publication
(10) Pub. No.: US 2020/0324239 A1
(43) Pub. Date: Oct. 15, 2020

(54) AIR CLEANER

(71) Applicant: Yi-Hsiung Lin, Tainan (TW)

(72) Inventor: Yi-Hsiung Lin, Tainan (TW)

(21) Appl. No.: 16/378,579

(22) Filed: Apr. 9, 2019

(51) Int. Cl. B01D 46/00

(52) U.S. Cl. CPC B01D 46/0071; B01D 46/0043; B01D 46/0023

(57) ABSTRACT

An air cleaner includes a housing, a fan, one or more filtering elements, and a washing system. The housing is provided with an air inlet and an air outlet. The fan is mounted in the housing at a location corresponding to the air outlet and rotated by a motor. The filtering elements are arranged in the housing below the air outlet while above the air inlet. The washing system includes a drain pan, at least one sprinkler, a water tank and a pump, is located in the housing. The drain pan is provided with a drainage port and obliquely arranged below the filtering elements. The sprinkler is arranged above the filtering elements. The water tank and the pump are mounted at a bottom of the housing. An injection pipe is connected to the water tank and extends out of the housing for filling the water tank with water and/or detergent.

### BACKGROUND OF THE INVENTION

### 1. Field of the Invention

The present invention relates to an air cleaner and, more particularly, to an air cleaner that is provided with a washing system to cleanse filtering elements thereof.

### 2. Description of the Prior Art

Due to rapid development of industrial technology, haze or air pollution in recent years is extremely serious. As we known, the aerosols in the air has a great impact on human health. To reduce the risk of air pollution, air cleaners or purifiers have been developed and have become an essential produce in many places. Typically, an air cleaner may employ filters to remove contaminants in air. The filters may include a pre-screening filter, an HEPA (high efficiency particulate air) filter, and an activated carbon filter. In use, a motor can drive a fan to draw outside air into the cleaner's housing, and then the air passes the pre-screening filter, the HEPA filter, and activated carbon filter and finally flows out of the housing to become clean air. To keep the performance of the air cleaner at an optimal state and to prevent an increase of energy consumption, after the air cleaner has been used for a period of time, the filters in the air cleaner need to be cleansed or replaced. This operation, which involves disassembling the air cleaner, is extremely time-consuming and labor-intensive.

### SUMMARY OF THE INVENTION

One object of the present invention is to provide an air cleaner, which allows the filtering elements thereof to be washed in their original places to solve the disadvantage of conventional air cleaners.

The air cleaner generally comprises a housing, at least one fan, one or more filtering elements, and a washing system. The housing is provided with at least one air inlet and at least one air outlet. The fan is mounted in the housing at a location corresponding to the air outlet. The fan can be rotated by a motor. The filtering elements are arranged in the housing below the air outlet while above the air inlet. The washing system, which includes a drain pan, at least one sprinkler, a water tank and a pump, is located in the housing. The drain pan is provided with a drainage port and obliquely arranged below the filtering elements such that the drainage port is at a lowest level of the drain pan. The sprinkler is arranged above the filtering elements. The water tank and the pump are mounted at a bottom of the housing, wherein an injection pipe is connected to the water tank and extends out of the housing for filling the water tank with water and/or detergent. In use, the motor can rotate the fan to cause outside air to enter the housing via the air inlet, and then the air passes the filtering element and finally flows out of the housing via the air outlet. In a washing operation, the pump can move water and/or detergent contained in the water tank via pipes to the sprinklers to wash dirt or contaminants off the filtering elements, and waste water can be collected by the drain pan and discharged from the drain pan through the drainage port.

The air cleaner of the present invention is advantageous in that the filtering elements thereof can be washed in their original places without being taken out, thus saving manpower and time.

Other objects, advantages, and novel features of the present invention will become more apparent from the following detailed description when taken in conjunction with the accompanying drawings.

### BRIEF DESCRIPTION OF DRAWINGS

FIG. 1 shows a 3-dimensional view of an air cleaner according to one embodiment of the present invention.

FIG. 2 shows a working view of the air cleaner, which is operated to generate clean air.

FIG. 3 shows another working view of the air cleaner, which is operated to cleanse the filtering elements therein.

### DETAILED DESCRIPTION OF THE PREFERRED EMBODIMENTS

To illustrate the effects and advantages of the present invention, a preferred embodiment is provided in the following paragraphs with reference to the accompanying drawings.

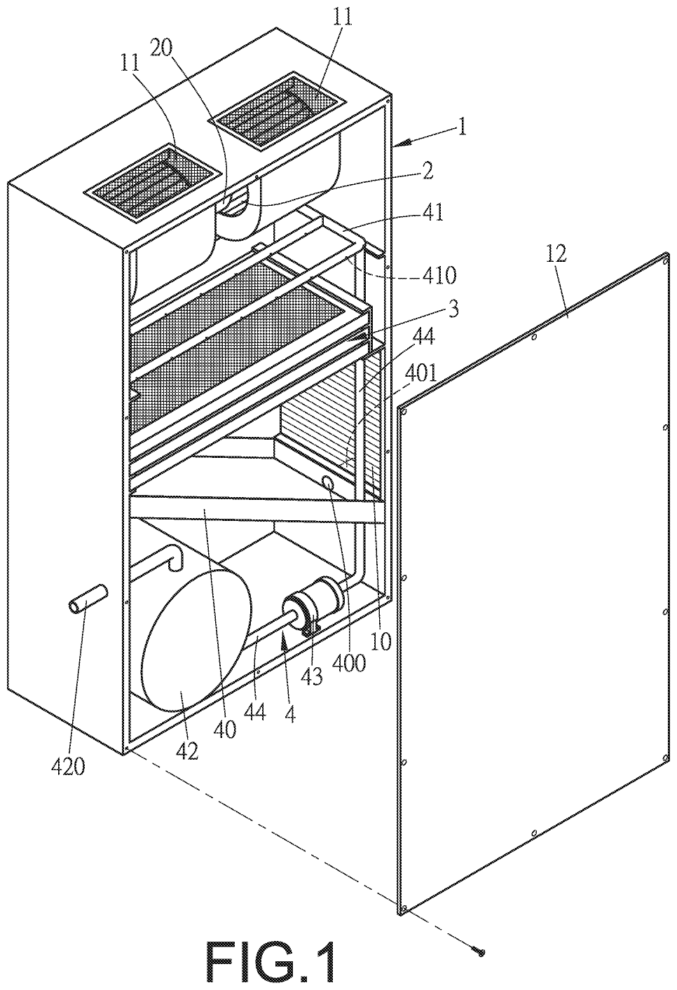

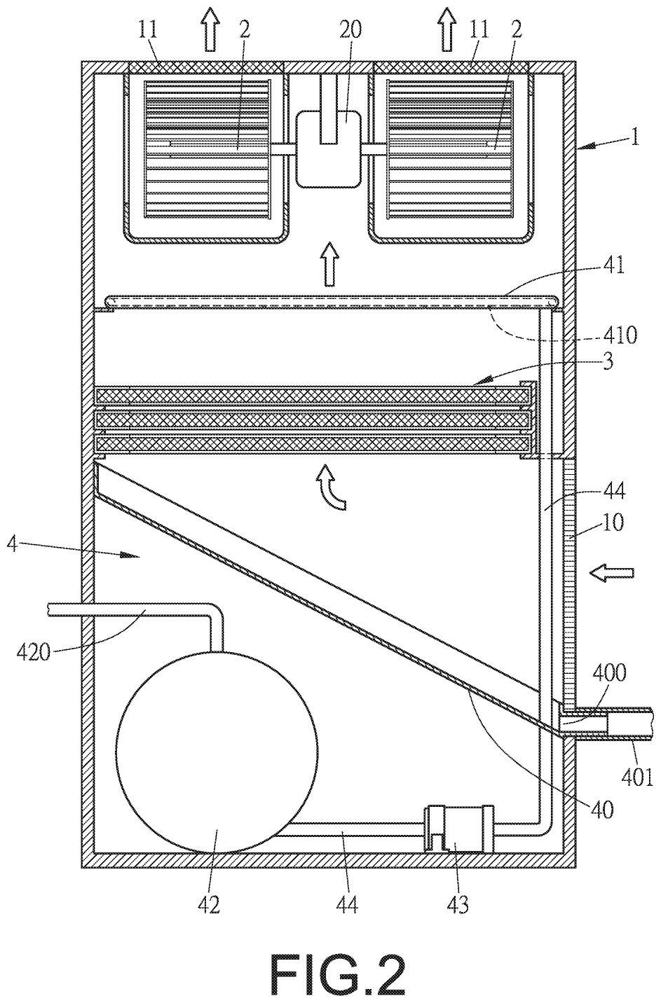

Referring to FIGS. 1 and 2, an air cleaner according to one embodiment of the present invention is shown, wherein a panel 12 is disassembled from a housing 1 of the air cleaner. In addition to the housing 1, the air cleaner comprises two fans 2, a plurality of filtering elements 3, and a washing system 4. The housing 1 is provided with one air inlet 10 and two air outlets 11. The two fans 2, which can be rotated by a motor 20 therebetween, are mounted in the housing 1 at locations corresponding to the two air outlets 11, respectively. The filtering elements 3, which may include a pre-screening filter, an HEPA (high efficiency particulate air) filter, and an activated carbon filter, are arranged in stack in the housing 1 below the air outlets 11 while above the air inlet 10. The washing system 4, which is located in the housing 1, generally includes a drain pan 40, a plurality of sprinklers 41, a water tank 42, and a pump 43. The drain pan 40 is provided with a drainage port 400 and obliquely arranged below the filtering elements 3. A drain pipe 401 is located outside the housing 1 and connected with the drainage port 400. The sprinklers 41, which are in the form of parallel pipes each defining multiple holes 410, are arranged above the filtering elements 3. The water tank 42 and the pump 43 are mounted at a bottom of the housing 1. An injection pipe 420 is connected to the water tank 42 and extends out of the housing 1 for filling the water tank 42 with water and/or detergent. Pipes 44 are connected between the water tank 42 and the pump 43 or between the sprinklers 41 and the pump 43. The panel 12 normally closes an opening of the housing 1 to conceal the components in the housing 1.

While the air cleaner is in use, as shown in FIG. 2, the motor 20 can drive the two fans 2 to rotate, which causes outside air to enter the housing 1 via the air inlet 10 and then to pass the filtering elements 3 and finally to flow out of the housing 1 via the air outlets 11. As the air passes through the filtering elements, the contaminants contained in the air are removed by the filtering elements, so that the air flowing out of the housing 1 would become clean.

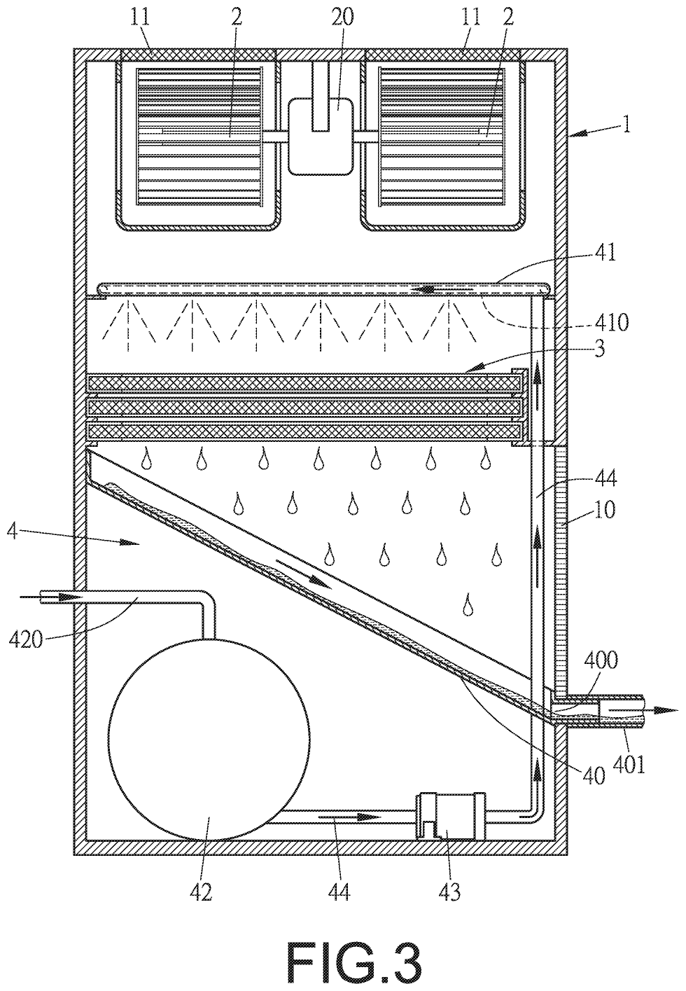

After the air cleaner has been used for a period of time, to maintain the performance of the air cleaner, the filtering elements 3 need to be cleansed. To cleanse the filtering elements 3, as shown in FIG. 3, the water tank 42 can be filled with water and/or detergent via the injection pipe 420, and then the pump 43 can be started to deliver water and/or detergent via pipes 44 to the sprinklers 41, from which water and/or detergent can be scattered down to the filtering elements 3 therebelow to wash off the dirt or contaminants accumulated on the filtering elements. During this process, waste water can fall down to the drain pan 40. Since the drain pan 40 is arranged obliquely, and the drainage port 400 is located at a lowest level of the drain pan 40, waste water can flow along the drain pan 40 to reach the drainage port 400, through which waste water can discharged from the drain pan 40 by way of the drain pipe 401. With the washing system 4, the filtering elements 3 can be washed in their original places without disassembling the air cleaner, thus saving manpower and time. This feature renders the air cleaner easy to use.

While the invention has been described with reference to the preferred embodiment above, it should be recognized that the preferred embodiment is given for the purpose of illustration only and is not intended to limit the scope of the present invention and that various modifications and changes, which will be apparent to those skilled in the relevant art, may be made without departing from the scope of the invention.

What is claimed is:

1. An air cleaner, comprising:
a housing provided with at least one air inlet and at least one air outlet;
at least one fan mounted in the housing at a location corresponding to the air outlet, the fan being rotated by a motor;
one or more filtering elements arranged in the housing below the air outlet while above the air inlet; and
a washing system, including a drain pan, at least one sprinkler, a water tank and a pump, located in the housing, wherein the drain pan is provided with a drainage port and obliquely arranged below the filtering elements such that the drainage port is at a lowest level of the drain pan, the sprinkler is arranged above the filtering elements, the water tank and the pump are mounted at a bottom of the housing, and an injection pipe is connected to the water tank and extends out of the housing for filling the water tank with water and/or detergent;
whereby the motor rotates the fan to cause outside air to enter the housing via the air inlet, and then the air passes the filtering elements and finally flows out of the housing via the air outlet; the pump moves water and/or detergent contained in the water tank via pipes to the sprinklers to wash dirt or contaminants off the filtering element, and waste water is collected by the drain pan and discharged from the drain pan through the drainage port.
